(19) United States
(12) Patent Application Publication
(10) Pub. No.: US 2009/0241048 A1
(43) Pub. Date: Sep. 24, 2009

(54) SYSTEMS AND METHODS FOR DISPLAYING A DATA MODIFICATION TIMELINE

(76) Inventors: Nancy L. Augustine, Pleasant Hill, CA (US); John Carr, Antioch, CA (US); Ben Goldberg, Pleasantton, CA (US); Randall Jones, Carrollton, TX (US); Cheryl L. Paterson, Alameda, CA (US); Ev Shafrir, Mountain View, CA (US); Gregg Stratton, San Francisco, CA (US)

Correspondence Address: WILSON SONSINI GOODRICH & ROSATI, 650 PAGE MILL ROAD, PALO ALTO, CA, 94304-1050, US

(21) Appl. No.: 12/408,619

(22) Filed: Mar. 20, 2009

Related U.S. Application Data
(63) Continuation-in-part of application No. 12/053,498, filed on Mar. 21, 2008.

(51) Int. Cl. G06F 3/048

(52) U.S. Cl. 715/769; 715/764; 715/808; 715/804

(57) ABSTRACT

Systems and methods for displaying data modification may include a user interface displaying a timeline with one or more items, which may include their own item timeline, corresponding to the same time period. A change made in item values may be reflected in the timeline. The invention may be applied to payroll or human capital management software, which may provide means for displaying payroll or human capital management information and how it is modified. Similarly, the timeline may also function as an information center that may display events and documents.

### CROSS-REFERENCE

This application is a continuation-in-part application of Ser. No. 12/053,498, filed Mar. 21, 2008, which is incorporated herein by reference in its entirety and to which application we claim priority under 35 USC § 120.

### FIELD OF THE INVENTION

This invention is directed to systems and methods of displaying data modification. The invention may be applied to payroll or human capital management software, which may provide means for displaying data modification of payroll or other human capital management information of employees.

### BACKGROUND OF THE INVENTION

Every employer is faced with the regular generation of payroll for its employees. Initially, payroll processing was an arduous manual task, requiring the responsible individual to compute the base pay, applicable taxes, and other deductions for each of the employer's employees. Initially, these calculations were performed by hand. Over time, automated systems have been developed to calculate pay, produce payroll checks, and even to make the automatic payroll deposits into an employee's bank account for employees participating in a direct deposit program. Automated systems have also been developed to deal with overall human capital management.

Prior payroll automation and human capital management systems generally provide an employer with the ability to analyze the payroll or to modify payroll data or parameters, or to management other human capital data. However, such payroll automation and human capital management systems may not provide a user display of payroll information that may show earlier values of payroll data and new values of payroll data over time and when any changes in payroll data may occur. Such payroll or human capital management systems may also fail to visually incorporate time, so that modifications made to payroll or other human capital management data may be reflected in a manner that relates to time.

There is a need for improved systems and methods for displaying data modification, especially for data including payroll and human capital management data, in a visually intuitive manner that may indicate change in data, which may reflect the passage of time.

### SUMMARY OF THE INVENTION

The invention provides systems and methods for displaying data modification. Various aspects of the invention described herein may be applied to any of the particular applications set forth below or for any other types of user interfaces and displays. The invention may be applied as a standalone system or method, or as part of an integrated software package, such as for payroll or human capital management software. It shall be understood that different aspects of the invention can be appreciated individually, collectively, or in combination with each other.

An aspect of the invention provides for a user interface shown on a display. For example, the implementation of software may include a client computer comprising a video display, with at least one display page comprising data. The data may include human capital management data, which may include data such as payroll data (including items such as wage compensation and benefits), workforce planning, recruitment, induction/orientation, skills management, training and development, personnel administration, time management, travel management, personnel cost planning, or performance appraisal.

Another aspect of the invention provides for a user interface which may include a graphical timeline displaying one or more item, each with its own item timeline. A graphical timeline may display one or more human capital management item timelines. An item may include any type of data item. For example, the timeline may display items relating to human capital management data, which may include data such as payroll data (including items such as wage compensation and benefits), workforce planning, recruitment, induction/orientation, skills management, training and development, personnel administration, time management, travel management, personnel cost planning, or performance appraisal, which may include items relating to taxes, earnings, deductions, direct deposit, personal information, time off, and so forth.

In another embodiment of the invention, items may also be directed to other pivot points of data. The pivot point may include any item of characterization. In a preferable implementation of the invention, a pivot point may be for an employee, so that a timeline may include item timelines for various data, such as human capital management data as mentioned previously. In another example, a pivot point could be a particular type of data, such as 401(k), and a timeline may include item timelines for various employees as the items. The item timelines for each employee may show each employee's 401(k) values and how they change.

In one embodiment of the invention, each item timeline may include an initial data value for the item at the earliest time period on the timeline if an initial data value exists at the earliest time period. An item timeline may also include a change indicator, if a data value of an item has changed, and the change indicator may appear on the item timeline so that it may correspond to a time where the data value of the item has changed. A data value of an item may be displayed as a new data value if the data value has changed. In a preferable embodiment of the invention, the data values may relate to payroll or any other human capital management data.

The timeline may have a number of orientations. In a preferable embodiment of the invention, the timeline may have a horizontal orientation with earlier times to the left and later times to the right. Each item timeline may be parallel to the timeline and may have the same orientation and relate to the same period of time.

The timeline may have additional features, such as time period indicators, which may be any visual indication of any time periods within the time period encompassed by the timeline. In a preferable embodiment of the invention, time period indicators may indicate pay periods. The timeline may also include time passage indicators which may correspond to a calendar time period. The timeline may also include a feature that when a user interacts with the timeline, such as by placing a pointing device indicator such as a mouse cursor over an item timeline, information about an item may be displayed. The timeline may include other features, such as means to add or remove an item from the timeline, or may display any additional information.

In accordance with another aspect of the invention, the timeline may reflect a change made using a various means for data modification. In one embodiment of the invention, the means for data modification may include a side by side display. In one implementation, the timeline and side by side display may be displayed together.

The timeline may also be used for document management in accordance with another aspect of the invention. Icons providing access to documents may be positioned at relevant locations along the timeline. Such document icons may be visually mapped to the relevant time and item. Document icons may represent actual documents (e.g., ready) or future delivery documents (e.g., placeholders). A user may also place a document icon on a timeline. A user may also place a request for a document on the timeline.

The timeline may be utilized by one or more entities, which may impose their own dates, events, documents, or rules in accordance with an embodiment of the invention.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The features and advantages of the invention may be further explained by reference to the following detailed description and accompanying drawings that sets forth illustrative embodiments.

FIG. 1 shows a system with client computers interacting with a server over a network.

FIG. 2 shows a timeline with items and item timelines.

FIG. 3 shows an interaction between an item timeline and a pointing device indicator in accordance with one embodiment of the invention.

FIG. 4 shows an embodiment of the item timeline.

FIG. 5 shows an embodiment of a user interface including a data modification interface, and a corresponding timeline.

FIG. 6 shows an embodiment of a user interface including a side by side display, and a corresponding timeline.

FIG. 7 shows an embodiment of a timeline displaying calendar events and document icons.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

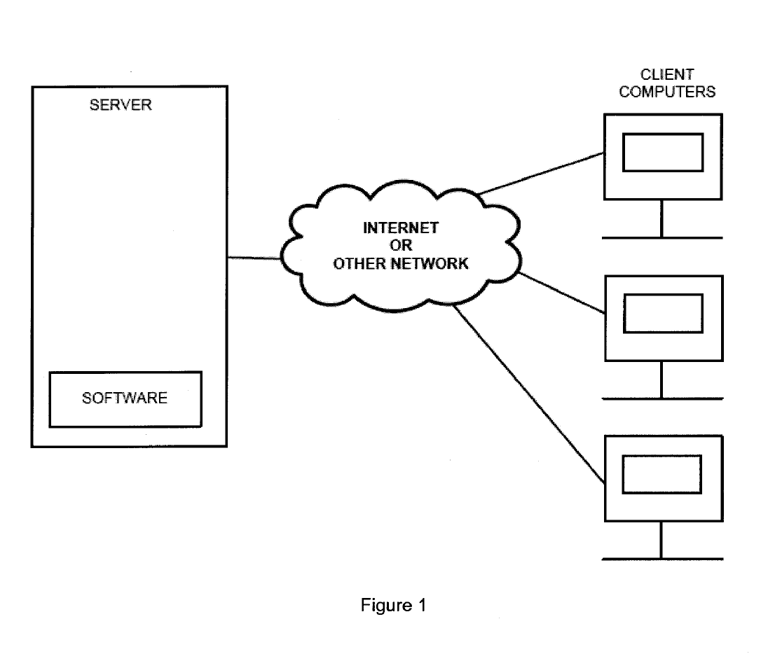

A user interface provided in accordance with the invention herein may be displayed across a network such as the Internet. For example, as shown in FIG. 1, an implementation of may include a client computer comprising a video display with at least one display page comprising data. The data may include human capital management data, which may include data such as payroll data (including items such as wage compensation and benefits), workforce planning, recruitment, induction/orientation, skills management, training and development, personnel administration, time management, travel management, personnel cost planning, or performance appraisal. Human capital management data may include data that can be person and time dependent. Human capital management may be heterogeneous across different businesses and a human capital management outsourcing software may advantageously display human capital management data.

Video displays may include devices upon which information may be displayed in a manner perceptible to a user, such as, for example, a computer monitor, cathode ray tube, liquid crystal display, light emitting diode display, touchpad or touchscreen display, and/or other means known in the art for emitting a visually perceptible output. Video displays may be electronically connected to a client computer according to hardware and software known in the art.

In one implementation of the invention, a display page may include a computer file residing in memory which is transmitted from a server over a network to a client computer, which can store it in memory. Similarly, one or more servers may communicate with one or more client computers across a network, and may transmit computer files residing in memory. The network, for example, can include the Internet or any network for connecting one or more clients to one or more servers.

At the client computer, the display page may be interpreted by software residing on a memory of the client computer, causing the computer file to be displayed on a video display in a manner perceivable by a user. The display pages described herein may be created using a software language known in the art such as, for example, the hypertext mark up language (“HTML”), the dynamic hypertext mark up language (“DHTML”), the extensible hypertext mark up language (“XHTML”), the extensible mark up language (“XML”), or another software language that may be used to create a computer file displayable on a video display in a manner perceivable by a user. Where network comprises the Internet, a display page may comprise a webpage of a type known in the art.

A display page according to the invention may include embedded functions comprising software programs stored on a memory, such as, for example, VBScript routines, JScript routines, JavaScript routines, Java applets, ActiveX components, ASP.NET, AJAX, Flash applets, Silverlight applets, or AIR routines.

A display page may comprise well known features of graphical user interface technology, such as, for example, frames, windows, scroll bars, buttons, icons, and hyperlinks, and well known features such as a “point and click” interface. Pointing to and clicking on a graphical user interface button, icon, or hyperlink also is known as “selecting” the button or hyperlink. A display page according to the invention also may incorporate multimedia features.

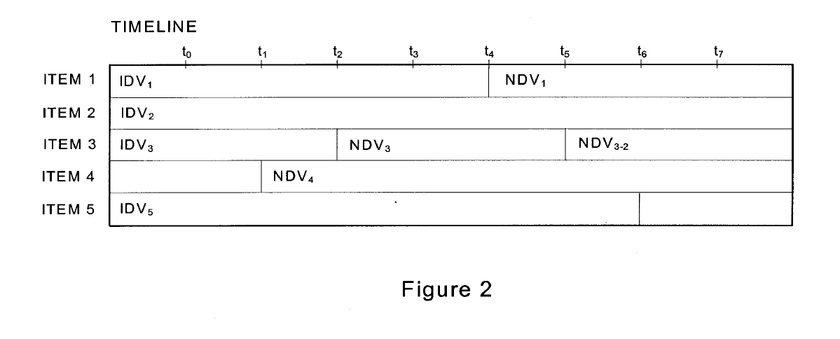

Referring to the drawings in detail, FIG. 2 shows a user interface provided in accordance with the invention that may include a graphical timeline, which may include items and item timelines. The aspect of the invention may provide for a user interface which may include a timeline displaying one or more item, each with its own item timeline. A graphical timeline may include payroll or human capital management items and payroll or human capital management item timelines.

An item may include any type of data item. In a preferable implementation, the timeline may display items relating to human capital management data, which may include data such as payroll data (including items such as wage compensation and benefits), workforce planning, recruitment, induction/orientation, skills management, training and development, personnel administration, time management, travel management, personnel cost planning, or performance appraisal. Similarly, the timeline may display items relating to payroll data, which may include items relating to taxes, earnings, deductions, direct deposit, personal information, time off, and so forth. For example, items relating to deductions may include items relating to retirement, such as 401 or IRA, or items relating to benefits, such as medical plans, dental plans, or vision plans, or items relating to insurance, such as supplemental life insurance, accident insurance, and any other miscellaneous items. Any description of items, their type, arrangement, or display, may also be applied to other embodiments of the invention.

The items may be grouped by topic. The items may be displayed such that they form a linear display such that the items are all at the same level, e.g., Item 1, Item 2, Item 3, etc. Such a linear display may be vertical or horizontal. In other implementations, the items may be arranged into groupings or have some form of organization that may be visually apparent. For example, there may be categories of items, and the items may be displayed below the category names and indented, or have any other visual indication that the items are associated with an item category. Item timelines may be grouped into related topics along with corresponding item titles. For examples, Taxes may be grouped by Federal, State, or Local. Earnings may be grouped into Employee earnings or Employer earnings. Deductions may be grouped into Voluntary deductions or Garnishments.

Items may be displayed in any order with any form of organization. For example, the items (and corresponding item timelines) may be vertically organized by category or topic. Such items may also be organized alphabetically, or have other orderings. Orderings may be combined; for example, items may be organized by topic, then alphabetically within the topic. Similarly, the topics themselves may be organized alphabetically, by importance, or by another order.

In some embodiments, item categories may be displayed in a list and it may be possible to open up an item category to get access to the items within the item category. One example of opening up or expanding an item category may include a list where item categories with one or more items may include a visual indicator that a user may select, which will allow the items within the item category to appear in the list below the item category. Thus, items may be displayed in a manner such that they are or are not associated with an item category in a visual manner, and such that items may or may not be hidden at a user's discretion. When items are hidden, associated values for the hidden items, such as corresponding item timelines, may be hidden as well.

In another embodiment of the invention, items may also be directed to other pivot points of data. The pivot point may include any item of characterization. In a preferable implementation of the invention, a pivot point may be for an employee, so that a timeline may include item timelines for various data, such as human capital management data as mentioned previously. A user may be provided with options in which items to display for a particular pivot point. In one example, the items shown for a particular employee may be limited by a category. For instance, a user may choose to view items for an employee relating only to deductions, or may choose to review items for an employee relating only to taxes. In this case, one timeline may include items for an employee relating to deductions, such as items relating to retirement, such as 401(k) or IRA, or items relating to benefits, such as medical plans, dental plans, or vision plans, or items relating to insurance, such as supplemental life insurance, accident insurance, and any other miscellaneous items. A user may be able to access an alternate timeline which may display items for the employee relating to another category, such as taxes. Alternatively, a user may be provided with an option to show all items relating to an employee. A single selection of an employee may show detailed payroll related setup (e.g., in a side by side view to be discussed further below), which may enable sequential modification actions down the company roster. Such interfaces for modifications may be displayed on a single screen. Such sequential modification may be provided such that after the detailed view for an employee is submitted, the detailed view for the next employee may be automatically displayed.

In another implementation, a pivot point could be a particular type of data, such as 401(k), and a timeline may include item timelines for various employees as the items. Such pivot points on one payroll item may advantageously enable a bird's eye view and comparisons. The item timelines for each employee may show each employee's 401(k) values and how they change. Again, a user may be provided with options in which items to display for a particular pivot point. For instance, there may be different employee work groups, so a user may have the option of viewing the 401(k) item timelines for employees within a particular work group. Or alternatively, a user may be able to choose an option to view the 401(k) item timelines for all employees.

Filters may be applied to the company roster or to available payroll focus items. For example, filters may apply to the company roster, such that a group of employees may be selected for comparison within a pivot point (e.g., a selected item). Filters may apply to payroll focus items to select an item or group of items to operate as the pivot point. Additionally filters may be provided to select an employee or group of employees as a pivot point.

In one implementation, a vertical arrangement of an entire company roster (or some subset thereof, such as an employee group) with effective date-segments (or date-range spans, or any other time period) of the same payroll related item or element may be provided. For example, all hourly employees who participate in 401(k) contributions may be vertically listed. In this situation, 401(k) contributions may be the pivot point. In other implementations, the arrangement may have any orientation—e.g., the employees may be horizontally listed.

In one embodiment of the invention, an item may be labeled for its corresponding item timeline. For example, an item name may appear adjacent to its item timeline. An item name may also appear within an item timeline. In an alternate example, an item timeline may be labeled by another representation of the item, such as an image or symbol.

An item timeline may include a visual timeline for each item. A timeline may include a plurality of visually mapped item timelines. For instance, the item timelines may be arranged to have a parallel orientation to one another so that they may correspond in time to the timeline and to one another. In one example, a timeline may have a particular orientation for a particular passage of time, and each item timeline may be oriented to correspond to the orientation and the passage of time.

An item timeline may be a representation of time with an orientation. For example, an item timeline may include a bar with a width and length. Alternatively, an item timeline may be a line. In another example, an item timeline may have a regular or irregular shape with an orientation and that may show the passage of time (e.g., an arrow). An item timeline may be comprised of a plurality of shapes as long as the plurality of shapes may somehow have an orientation and passage of time, such as a series of circles lined up in a row.

In a preferable embodiment of the invention, a timeline may have a horizontal orientation and an item timeline may also have a horizontal orientation and correspond to the time of the timeline. The horizontal orientation may be such that earlier times may be to the left and later times may be to the right. There may be more than one item timeline, where each item timeline may also have a horizontal orientation and correspond to the time of the timeline. Each item timeline may comprise a bar with a length and width. The item timelines may be parallel to one another and may be stacked alongside one another. For instance, if a timeline included a period of time from March 1st to June 30th, each item timeline may also include a period of time between March 1st and June 30th so that the time of each item timeline referring to a particular time is lined up to the same time within the other item timeliness If the item timelines are oriented horizontally, the same times may run vertically, so that April 15th of one item timeline may be directly vertical to April 15th of another item timeline.

In one embodiment of the invention, the item timelines of a timeline may have the same length. For instance, regardless of the value of item of the item timeline, a visual depiction of the item timeline may start at the beginning of the time included by a timeline and may end at the end of the time included by the timeline. For example, if a timeline included a period of time from March 1st to June 30th, each item timeline may also start at March 1st and end at June 30th so that the times of each item timeline may line up to the same time for the other item timelines. Even if an item timeline did not have a value during this time, a visual depiction of the item timeline may exist for the whole time, even if the value was a nullity for the part of the time, and may be indicated as such on the display.

In an alternate embodiment of the invention, the item timelines of a timeline may have varying lengths. For instance, if a value of an item timeline starts at a particular time within the time period included by the timeline, the item timeline may start at that time. Or if a value of an item timeline ends at a particular time within the time period included by the timeline, the item timeline may end at that time. For example, if a timeline included a period of time from March 1st to June 30th, and an item timeline did not have a value until March 15th, the item timeline may start at March 15th and may end at June 30th. Or if an item timeline had a value that could end on May 1st, the item timeline may start at March 1st and end on May 1st.

Similarly, an item timeline may be broken up if it switches between having values and not having values during a time period included by a timeline. For example, if a timeline included a period of time from March 1st to June 30th, and an item timeline did not have a value starting April 15th, but then would have a new value starting May 15th, the item timeline may start at March 1st and end on April 15th, and then start on May 15th and end at June 30th.

In one implementation, if an item timeline were to have a value beyond the time displayed, the item timeline may provide some sort of visual indication that the item timeline goes beyond the time displayed, as opposed to starting or ending. Such a visual indication may include a color indication, such as a gradual color change at the beginning or end of the displayed item timeline, as opposed to an abrupt color change. In another embodiment, there may be some sort of shape change or addition, such as an arrow pointing beyond the item timeline. The invention may advantageously provide the concept of ongoing time, including the concept of “ever since” and “forever” or “indefinitely.”

A timeline may also include a time period indicator. A time period indicator may be any visual indicator showing the time period included by the timeline. For example, a time period indicator may include a tick mark for a particular time period, such as a pay period. The time period indicator may also include a value indicating which time the time period indicator is indicating. For example, if a timeline included a period of time from March 1st to June 30th, and a time period indicator were indicating pay periods that occur every 10 days, the time period indicators may include tick marks with March 1st, March 11th, March 21st, March 31st, April 10th, and so forth. A time period indicated by a time period indicator may not have to have a uniform length.

In one embodiment of the invention, each item timeline may include a data value for the item of the item timeline. A data value may have any visual representation incorporated into the item timeline. For example, a data value may be shown as a numerical value of an item and may be represented by the number. Alternatively a data value of an item may be represented by a word, a symbol, a pictorial representation, an icon, a color, a pattern, or any combination thereof. Even if a value of an item may be something specific, such as a number, the data value may be represented as something that represents the category, class, or range of the specific value, such as a color representing a range of numbers.

In one embodiment of the invention, each item timeline may include an initial data value for the item at the earliest time period on the timeline if an initial data value exists at the earliest time period. An initial data value may be a data value of the item timeline which may exist at the start of the time period included by the timeline. If a timeline includes a period of time from March 1st to June 30th, an initial data value for an item timeline may be the data value for the item timeline on March 1st. If an item timeline does not have a data value at March 1st, it may not have an initial data value.

An item timeline may also include a change indicator. If a data value of an item has changed, the change indicator may appear on the item timeline so that it may correspond to a time where the data value of the item has changed. A change indicator may be any visual indication that a data value of an item has changed. For example, a change indicator may be represented by a line that divides an item timeline. A change indicator could also include some sort of color change, or change in shape of the item timeline, or some sort of visual symbol or picture or any other cue.

If the value of an item changes, an item timeline may include a new data value for the item. A new data value may or may not be visually displayed in close proximity with a change indicator. A new data value may also be used as a change indicator. In one embodiment of the invention, if an item were to end within the time period included by the timeline, a new data value may not be displayed to indicate the end of item, or a new data value may be displayed to represent a nullity.

In some embodiments of the invention, an item may start or end within the time period included by a timeline. The start or end of an item may be visually indicated. For example, the start or end of an item may be indicated by a bar to divide an item timeline. Or the start or end of an item may be indicated by the start or end of the item timeline itself. In one embodiment of the invention, an item timeline may have a color while it has a value, and the period of time before a start of an item and the period of time after the start of an item may be white. In another embodiment of the invention, an item timeline may be white or some other color, but may have a gradual shading of color toward the start or end of the item timeline.

In one embodiment of the invention, an item timeline may have various color changes that may denote different meanings. For example, an item timeline may have a sudden color change when the data values before and after the color change are distinct and sudden. An item timeline may have a gradual color change when values before and after the color change occur gradually.

In a preferable embodiment of the invention, an item timeline may have a gradual color change at the start and end of the displayed item timeline to represent values that outside the range of the times displayed that are consistent with displayed values. For example, if a particular item were to have a value that were to change on November 1, but the timeline only displays item timelines from July 1 to October 1, the item timeline may have a gradual shading at the end of the portion displayed to indicate that the data value may remain the same for some time after October 1.

In accordance with one embodiment of the invention, a timeline may also include time passage indicators. Like time period indicators, time passage indicators may be any visual indicator showing the passage of time during a time period included by the timeline. For example, a time passage indicator may indicate the passage of time in calendar increments, such as years, months, weeks, or days. A time passage indicator may be used in conjunction with a time period indicator. A time passage indicator may include any visual indication, such as a tick mark that shows a passage of time. The time passage indicator may also include a value indicating which increment of passing time the indicator is indicating.

For instance, if a timeline included a period of time from March 1st to June 30th, and a time period indicator were indicating pay periods that occur every 10 days, the time period indicators may include tick marks with March 1st, March 11th, March 21st, March 31st, April 10th, and so forth. In this example, time passage indicators may indicate every month, which may include putting tick marks where each new month starts, and may include labels for March, April, May, and June.

One embodiment of the invention may include an indicator denoting a time where values of items may be ascertained. The indicator may be any visual indicator showing a particular time within the time period included by the timeline. In one implementation, the indicator may be a bar going across all the item timelines. In another embodiment of the invention, there may be more than one indicator denoting particular times where values of items may be ascertained. The indicator may also include a label, which may or may not describe the significance of the particular time indicated. The indicator may provide a cross-sectional view of the values of the various items at a particular time.

An item timeline may be visually mapped to relevant times and to a relevant item. An item timeline may be visually mapped to a time passage indicator or item if they are somehow visually aligned or correspond, or show a relationship between them. One example of visual mapping may occur when the item timeline and items or time passage indicators are in the same row or column (e.g., given an x-y coordinate system, a plurality of objects may be visually mapped if they share the same x-coordinate while the y-coordinate may vary, or if they share the same y-coordinate while the x-coordinate may vary). Such implementations of visual mapping may also apply to other features displayed on a user interface.

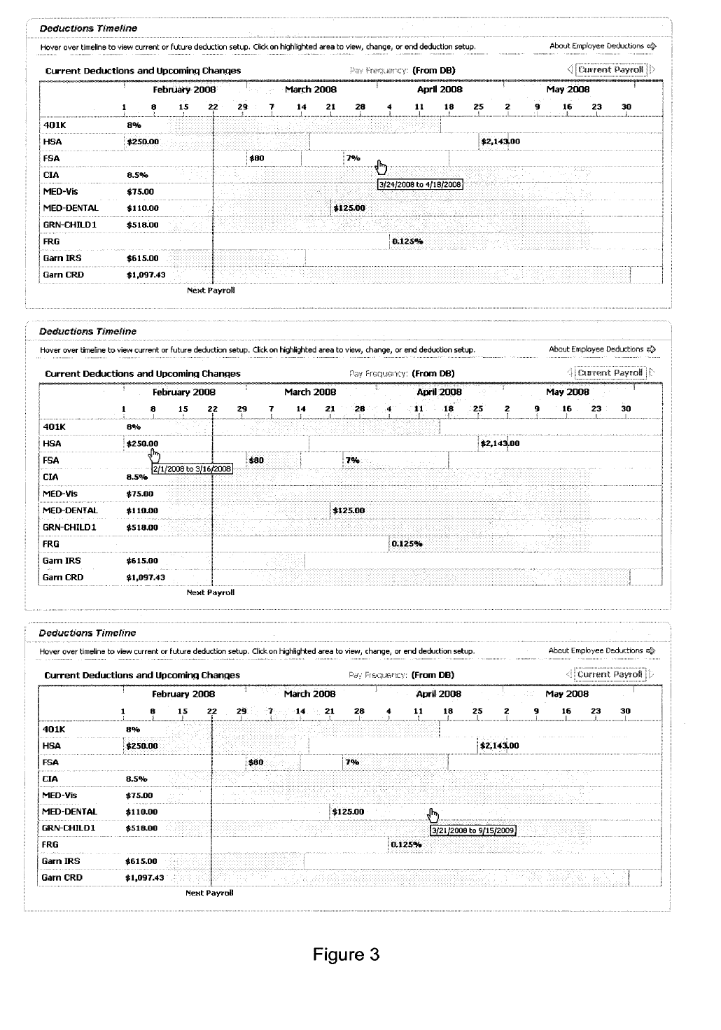

In a preferable embodiment of the invention, the indicator denoting a time where values of items may be ascertained may be indicating the next payroll time, as shown in FIG. 3. The indicator may include a label indicating that the particular time is for the next payroll. An indicator may also be provided which may indicate the present time. For example, the indicator may be for “Today.” The indicators may have any visual format that may accentuate the relevant time. For example, the indicator may be a vertical hairline, or a horizontal hairline, or any hairline or bar running perpendicular to the orientation of the item timelines. The indicator may also have any other visual appearance for indicating the relevant times or events as known in the art.

In some embodiments, users or corporate policy may add other markers for events. As discussed previously, such markers may be vertical hairlines. These markers may be for significant events, or any event which may have a recurring nature. For example, markers may also be provided for “Q3 Filing” or “End of Fiscal Year.” Smart rules may be provided that may automatically place such markers on business days. For example, if a calendar quarter ends on Saturday, March 31, the Q1 filing deadline marker may be placed on Friday, March 30.

FIG. 3 shows an interaction between an item timeline and a pointing device indicator in accordance with one embodiment of the invention. A user may interact with a display using a number of input-output devices, such as a mouse, trackball, keyboard, touchpad, or any other pointing device. By interacting with an input-output device, such as a mouse, a user may control a pointing device indicator on the display device. For example, common pointing device indicators may include an arrow-like mouse cursor, or pointers of various shapes, such as hands, cross-bars, hourglasses, brushes, or pencils. A pointing device indicator can take any number of visual forms.

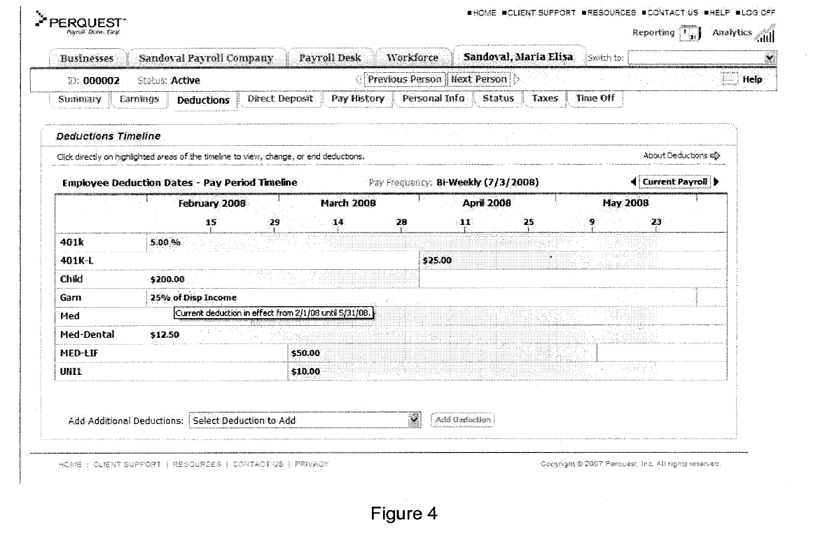

In one implementation of the invention, if a user were to move the pointing device indicator over an item timeline with a data value, the user interface may display information about the item timeline. For example, in a preferable embodiment of the invention, the information may be the period of time for which the item may have that data value. The period of time for which the item may have a data value may include time beyond the time period included by the timeline. In another example, the information may be about the data value of the item timeline as shown in FIG. 4.

The information about an item may be displayed in any visual manner. In a preferable embodiment, the information may be displayed in a popup. The popup may remain as long as the user's pointing device indicator is over the relevant portion of the item timeline. The relevant portion of the item timeline may be the part of the item timeline with a particular data value. The popup may disappear as soon as the user moves the user's mouse so that the indicator is off the item timeline portion, or alternatively, the popup may disappear after a brief delay (i.e. several seconds) from when the user moves the user's indicator off the item timeline portion.

Placing a pointing device indicator on a section of an item timeline may also cause other visual changes in the timeline. For instance, placing a pointing device indicator, such as a mouse cursor over an item timeline may cause that item timeline to change color. This may enable the particular item timeline to stand out. Placing a pointing device indicator over an item timeline may also highlight the item of the item timeline or somehow cause it to be visually distinct from other items in the timeline.

In one embodiment of the invention, if a user were to click on an item timeline, a user may be able to access underlying data. For instance, if a user were to click on an item timeline, a popup may appear with additional information. Alternatively, if a user were to click on an item timeline, a user may navigate toward a different page with data relating to the item. In another example, clicking on an item timeline may result in another window opening with data relating to the item.

A timeline may also include a means to add a new item to an item timeline or to remove an item from an item timeline. For example, the means to add a new item may be a data interaction interface, which may include a field to enter an item, a drop down menu to select an item, or an option to select an item, or any other means of interacting with data.

In some embodiments of the invention, the user interface may include various tabs. FIG. 4 shows one embodiment of the invention where there may be major tabs for information about a business, payroll data, directory of employees, and information about a specific employee. There may also be smaller tabs referring to specific aspects of the information provided by the major tabs. For example, there may be multiple minor tabs, such as under a specific employee, there may be smaller tabs for a taxes, earnings, deductions, direct deposit, summary, personal information, pay history, time off, status, labor, or any other payroll information relating to a specific employee. One of these minor tabs may be selected and may display a timeline relating to the selected tab. The user interface may also include additional navigational tools such as options to select the next employee, and so forth.

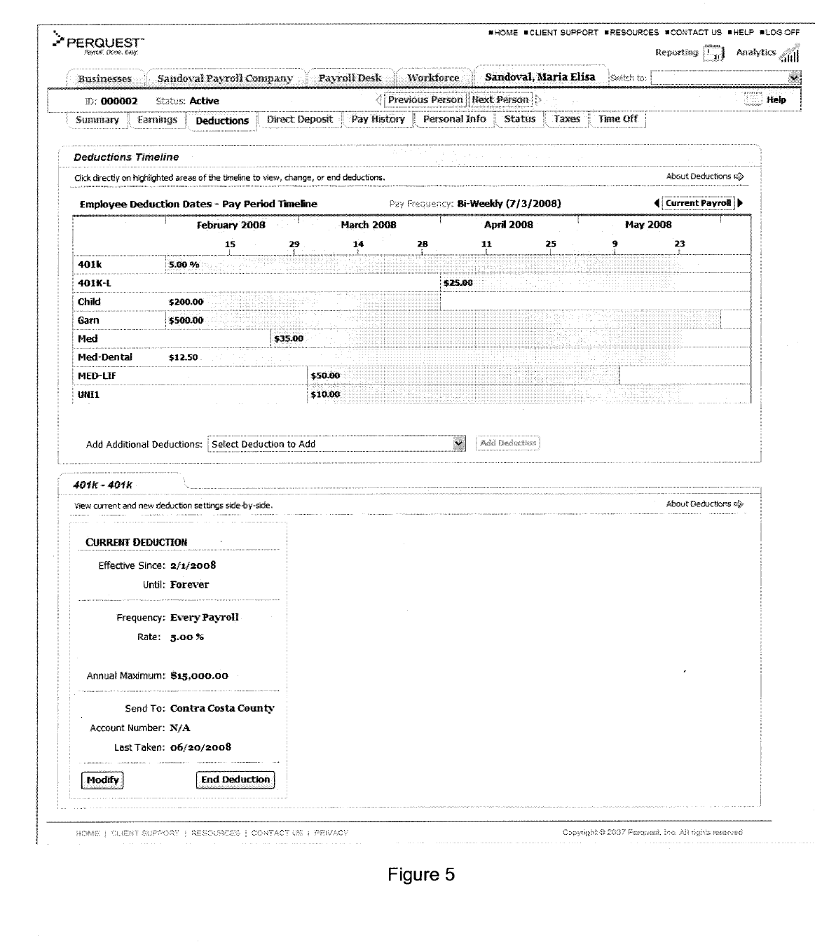

FIG. 5 shows an embodiment of a user interface including a timeline which may reflect data modification made by some data modification interface. In one embodiment of the invention, a data modification interface may include a side by side display. A side by side display which may include a current data region and a new data region, where the current data region contains current data values and a new data region may contain data interaction interfaces or data values corresponding to the current values and substantially mirroring them. A user may interact with data interaction interfaces to modify a data value. Embodiments of a side by side display are described in U.S. Patent Application No. 12/053,467, which is hereby incorporated by reference in its entirety. The data modification from a side by side display may be reflected in the corresponding timeline.

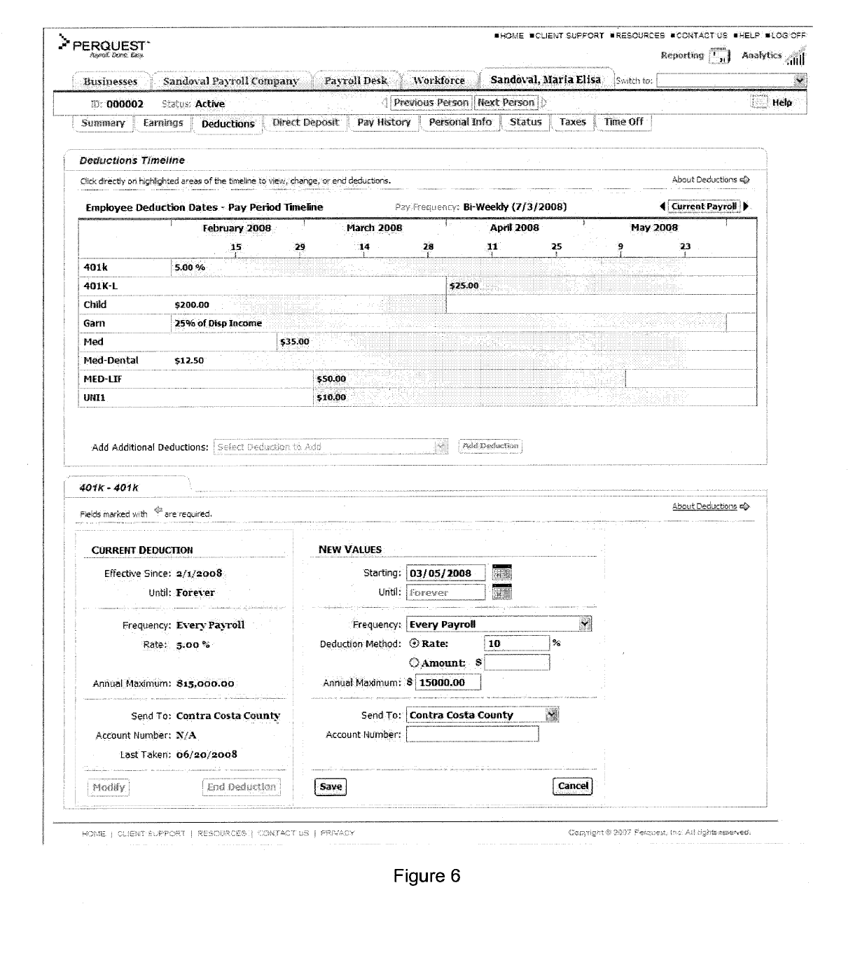

For example, if a deduction for a 401(k) item were changed to a percentage value starting a certain day in the side by side display, the timeline could indicate the change in the item timeline for 401(k). Such a change may occur by a user selecting an item on the item timeline. Selecting an item may cause a current data region with current values relating to the item to appear. A user may select an option to modify the current values, which may cause a new data region to appear, which may include data interaction interfaces or data values to appear. A user may interact with a data interaction interface to change a value. For instance, as shown in FIG. 6, a user may change an item value and choose to save the change. The change may be reflected in the item timeline by a change indicator.

In accordance with one embodiment of the invention, the timeline and the data modification interface may be displayed together. For example, a side by side display may be labeled as an item of the timeline. In one embodiment of the invention there may be multiple tabs, and the tabs may be selected and may display a timeline relating to the selected tab. Similarly, the side by side display may relate to an item selected from an item timeline, or may relate to an item to be added to the item timeline.

A single selection of an employee may show detailed payroll related setup for that employee. Sequential modifications of various employees may be made down a company roster. Such modifications may occur on a single screen. The detail payroll related setup for an employee may be displayed in any user interface, such as an additional pane, window, or tab. For example, the setup may be showed in a side by side card. In one example, sequential modifications may be made for a group of employees where modifications may be made in a detailed view, such as a side by side card. Once those modifications are submitted, a subsequent side by side card for the next employee in the group may be provided. This may be repeated until the cards for all of the employees within the group have been presented. A user may be able to enter or exit this sequence at any point.

Additionally, company wide cross lists may be available for employee setup templates and batch setups. For example, quick setup of employee payroll items may be enabled with user-created standard setup collections. Any interface for collecting relevant data for an employee may be provided. In some instances, this may be a side by side comparison where the data values in a current data region are blank or have default values, and the new data values in a new data region may be the information about the employee being entered.

Similarly, when modifying data values, side by side comparisons may be used. For example, a “New” or “Modify” card may be utilized to add, remove, or change the value of data. A data value may be added if the current data region of a card did not have a value for a particular data item, and a value is added for that data item in the new data region of the card. A data value may be removed if the current data region of a card had a value for a particular data item, and the value is removed for that data item in the new data region of the card. A data value may be changed if the current data region of a card had a value for a particular data item, and the value is modified for that data item in the new data region of the card.

It may be possible to add, remove, or modify a value with a selector enabling complete customer setup. This may not require the customer to type ‘Based on <template name>’ or similar commands. Templates may be computationally smart. For instance, ‘Maximum 401 (k) contribution’ may compute differently for each employee. Also, it may be possible to batch-setup all employees in a group (or any subset of a company roster) with an ‘Apply-to-all’ template. Similarly, it may be possible for a modification made to one employee to be applied to all employees. Also, rules applying to all employees may be modified, added, or removed. In providing such batch modifications, smart templates may be applied. Any such template may be applied to any employee or group of employees, which may affect possible data values for employees.

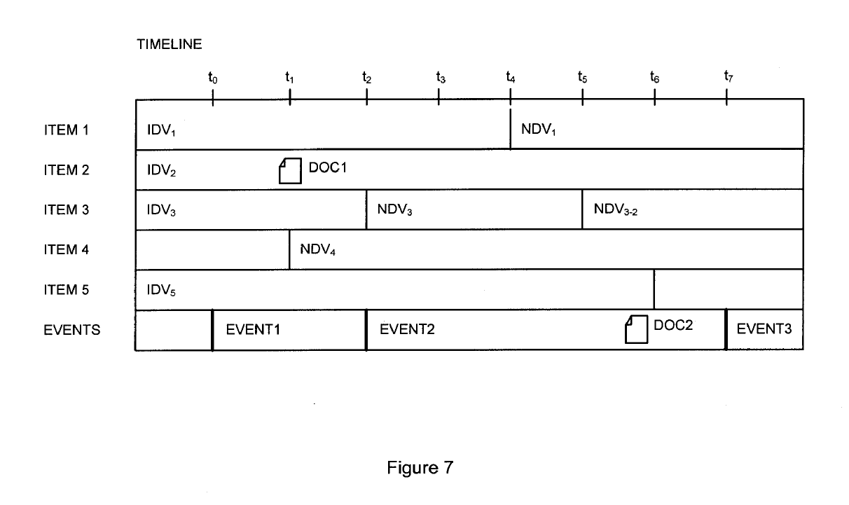

In accordance with another embodiment of the invention, a timeline may also function as an information center. FIG. 7 shows a timeline that may function as an information center. An information center may function primarily as a document delivery, storage and/or publishing tool. For example, icons (or any other form of visual indicator, e.g., as discussed elsewhere) representing a variety of documents or document types may be positioned along a timeline. The document icon may be positioned along the timeline to correspond to a relevant time for the document. For example, if a document represented by the document icon is relevant for a specific date, it may be located on the timeline to be visually mapped to that date. FIG. 7 shows an example of a first document icon, DOC 1, which may provide access to a document relevant at t₁ time, and may be related to Item 2, and a second document icon, DOC 2, which may provide access to a document relevant at t₆, and which may or may not be related to an event.

A document icon may have any appearance that may indicate a document or type of document. In some instances, the document icons may differ for different types of documents. Thus, they may visually indicate what type of document they are for. Multiple types of documents may be placed along a timeline. For example, some types of documents may include single documents, which may be familiar document types, and their associated familiar icons (e.g., a Microsoft Word document) may be used, or other icons may be used. A timeline functioning as an information center may or may not include items and related item timelines. Another document type may include packs, which may be a collection of single documents, that may be prepared together (e.g., similar to a folder). Documents may also be reports, which may be prepared by recipe into format templates. Further examples of document types may include: organizers (which may be binders or document bins), paychecks (which may be grouped pay vouchers which can be depicted as envelope bundles), electronic date interchange (EDI) documents (which may be machine-created for use by other machines), general ledger (GL) documents (which may include accounting documents, and may be a type of EDI), XML or CVS formatted documents (which may be types of human-readable EDI used for a variety of system-to-system data transfers), and Excel or Office Docs (which may be used for providing information, ready-templates, and soliciting subscriber entries). In some embodiments, document icons may also represent a request for a document, rather than an existing document.

Several examples of documents that may be accessed through a timeline may include, but are not limited to, various payroll documents (such as quarterly government payroll tax filings, periodic garnishment reports, or EEO government required reports), various human capital management documents, various human resources management documents, or other types of documents that may be useful in running a company. One example of a payroll document or package of documents may include, for each payroll, a single package with all related payroll accounting reports. General ledger accounting files may also be accessed through a timeline.

Furthermore, documents may have different states of readiness. The document icons may indicate what state of readiness that a document has. Such indication may be apparent in icon shape, size, color, label, or any other icon characteristic. Some examples of states of readiness may include: ready and current (e.g., most current government EEO filing), ready and stored (e.g., last month's payroll report), or ready on <future date> (e.g., faint icon and time span may show future date to expect item). Document icons may represent actual documents (which may have a state of readiness), or future delivery documents (which may be placeholders).

Each icon may represent a time period span for which the document is relevant for. A timeline may include a visual representation of the time span valid for the document. For example, if a document covers a longer period of time, the document icon may be wider or bigger than a document icon that relates to a document for a shorter period of time. Similarly, other visual indications may be used to indicate different time spans covered by a document, such as color, highlighting, bold, additional icons, arrows, bars, etc. For example, for a document relating to a long span of time, a bar may be placed in close proximity to the icon that visually maps to the time period covered by the document. In some instances, the bar may have a similar appearance to an item timeline.

Document icons may be highlighted when a pointing device indicator is over the icon. They may also be further highlighted after being selected. A document icon may remain highlighted while the pointing device indicator remains over the icon. A document icon may remain highlighted once it has been selected, even if the pointing device indicator is no longer over the icon. In some instances, when a pointing device indicator is over an icon or when an icon has been selected, additional information about the corresponding document may be provided. Such additional information may be displayed in another window, tab, popup, or in a region on the same user interface.

A timeline that may function as an information center may include a calendar, which may be a composite including all payroll frequencies in effect in a company. For example, a calendar strip may superimpose or vertically list and label all recurring, once-a-year, very special once-in-a-blue-moon, or one time dates. A calendar may also include any internal company payroll related dates. In some instances all company payroll related dates may be included, while in other instances they may be selectively included. Some examples of events may include payroll dates, such as deadlines to submit forms, or deadlines to make any changes. Other examples of payroll events or dates may include any external dates associated with government filings, or dates that may arise from integration with financial software, which may add financial accounting dates, audits, and so forth. Other examples of events that may be displayed may include human resources events, such as hiring dates, birthdays, anniversaries, retirements, and so forth. FIG. 7 shows an example of a timeline that displays relevant dates. For example, Event 1 may occur at time t₀, Event 2 may occur at time t₂, and Event 3 may occur at time t₇. An event indicator may have any appearance that may visually map the event with a relevant time. For a discrete event, the event indicator may be small or compact, such as a vertical bar. For an ongoing event, the size of the event indicator may correspond to the timespan of the ongoing event. For example, like an item timeline, an ongoing event may have a start and/or end time. Rather than a data value, an event name or description may be provided.

Similar to other components of a timeline, an event may be highlighted when a pointing device indicator is over an event indicator, or when an event indicator has been selected. Additional information about an event may be presented when a pointing device indicator is over the event indicator, or when the event indicator has been selected. Such additional information may be displayed in another window, tab, popup, or in a region on the same user interface.

In some instances, the calendar may be overlaid over an existing timeline which may display items and corresponding item timelines. In some instances, the calendar may run parallel to the existing timeline, e.g., may be provided in a separate pane adjacent to the timeline. In some instances, the calendar may be part of the timeline, but the dates or events indicated by the calendar may be below or somehow visually separable from the event timelines and/or document icons. Any of the features may be combined or visually separable. For example, an item timeline for a payroll may have a date at the end that indicates that checks are distributed. A document icon may be placed at the end of this item timeline that may be a statement of the pay that is distributed. Any or all of these components may be provided on a timeline. For example, a timeline may only include item timelines with data values, a timeline may only include documents, a timeline may only include a calendar of events, or a timeline may include any combination of these features.

In addition to displaying item timelines, which may indicate a value for an item at a particular time, a timeline may visually indicate any event relating to time, or provide access to any document or interface that may be related to time. A document may have various ways of relating to time. For example, a document may relate to a time that the document is due (e.g., payroll submission deadline for a payroll form), a time that the document was created, a time that the document was updated or last edited, a time a document ought to be reviewed, a time a document was submitted, or a time a document was destroyed. Anything displayed on the timeline may be visually mapped to a relevant time passage indicator, so that it may be displayed in the proper location with respect to time. Similarly, anything displayed on the timeline, may also be visually mapped to an item, or any other label or indicator which may be relevant to what is displayed. For example, as shown in FIG. 7, a document, DOC 1, may be visually mapped to a time passage indicator t₁, and an item, Item 2. For example, if Item 2 relates to health benefits, DOC 1 may be a document for the various health benefit selections of an employee, and time t₁ may be the submission deadline to make any changes to health benefit selections.

A timeline that may function as an information center may be utilized to present workflow driven tasks. Such workflow may be driven by a company, organization, or entity. In one example, after a filing document is published on a timeline, a company may have an internal workflow with that document. In addition to a download, a document icon may embody the start of a multi-step workflow in a payroll or human resources application. A timeline may be displaying a ‘workflow ticket’ which may include a document icon (i.e., as a starting form) at a time point along the timeline when an action relating to the document icon is possible, relevant, or mandatory. In some instances, some sort of time indicator, such as a hairline, may be displayed at the timeline where the document icon is located. A user may then click to start the workflow, and perform actions, such as entering data, authorizing progress, or submitting, creating, or passing along one or more documents.

A timeline may include a task icon displayed thereupon. A task icon may display a task progress state in addition to a type of task. In some instances, a task icon may be for a payroll or human resources task, such as a payroll icon. For example, a payroll icon (e.g., for a weekly payroll) may be displayed in one or more states as actions occur or time passes. In one example, such states may include (1) a future state, (2) a started state when someone (such as someone in another role) has started it, (3) worksheets and time import completed (e.g., when data entry is completed by someone else), (4) ready for the user's approval (e.g., now the viewing user role can and must do something with the payroll icon) to review and submit, and (5) submitted. A user may select the payroll icon to access a relevant application, such as the application to review and submit the payroll. In some situations, a task icon may be a document icon that may provide access to a document, such as a document for a user's review. Thus, in a workflow, a timeline may function as a launching pad to application pages.

The timeline may utilize information filters to focus on a specific time frame or item. An information filter can be used to focus on a specific date. For example an information filter may be used to control the amount of time displayed in a timeline. Controls may be provided that may change the size of the time span displayed. For example, rather than showing one payroll period it may show two, or rather than showing an upcoming week it may show an upcoming month. Controls may also be provided to change which time period is displayed. For instance, rather than showing the current pay period, it may pan along the timeline to show an upcoming time period, or rather than showing the present week, it may show the past week.

Furthermore, an information filter may be used to focus on a data type. For example, only data relating to a particular data category may be displayed (e.g., relating to taxes, or deductions). Selected items or groups of items may be displayed if selected by the filter. In one implementation, a user may focus only on government filing documents or only on payroll reports. Similarly, only particular types of data may be displayed. For example, data relating to an item value in an item timeline, data relating to documents, or data relating to particular events or dates. Visual filters may be depicted as document binders or document bins, which may include time-period labels.

A timeline may be displayed in a window of any size, and may have any proportion to a window. For example, a width or length of a timeline may be variable and may fit within a window size or for an application provided. For example, in a full-scale payroll application, a timeline may take up nearly the full screen width. In another example, in a smaller toolkit application such as a gadget, widget, or any other sort of simplified tool or application, the timeline may take up less of the screen width (e.g., about ⅓ screen width) depending on the user interface for the smaller toolkit application.

In a preferable embodiment, the timeline may be provided as a continuous horizontal strip of time, which may be panned in a continuous or discrete manner, or zoomed in and out in a continuous or discrete manner. In some instances, panning may occur through pan controls such as pressing a button or dragging a bar, or may occur directly such as by click-and-dragging the timeline or calendar strip backwards or forwards in time (e.g., horizontally from side to side). The timeline may have any orientation; e.g., it may be a vertical strip of time, or diagonal strip of time.

One example of a zoom or detail view tool may be a user-controlled cursor that may slide over the timeline. For example, if the timeline is a horizontally oriented timeline, the user-controlled cursor may slide left and right along the timeline. If the timeline has another orientation, the cursor may slide along the length of the timeline (e.g., like a sliderule). The cursor may have any appearance. In one implementation, the cursor may be translucent or substantially transparent. The cursor may have any shape or orientation. The cursor may be have a vertical orientation or may be oriented to be perpendicular to the length of the timeline. The cursor may highlight and zoom-larger any document activity or any other type of activity that may occur within a narrow time focus. For example, within a wide time view (e.g., such as a 1 year timeline), the cursor may highlight a smaller time window (e.g., 1 day or 1 week). The area under focus by the cursor may be displayed in a zoomed-larger view, which may be anywhere on the user interface. In some instances, the zoom-larger view may be displayed adjacent to the timeline, adjacent to the cursor, or superimposed over part of the timeline. Special calendar events may be titled or labeled within text above, below, or adjacent to the timeline area, and holidays or other special days may be so marked on the timeline.

The time window selected for display by the timeline (e.g., 1 week, 2 weeks, 1 month, 3 months, 6 months, 1 year) may determine the size of document icons and document spans that may be positioned on the timeline. For example, in a 3 month view, the icons may be full size, while in a 1 year view, month and week separators (or any other time period indicators) may be added and document icons may be smaller. Similarly, depending on the time displayed, different time period indicators may be displayed. For instance, in a week view, time period indicators for each of the days may be provided, while in a year view, time period indicators for each of the months may be provided.

Various users may view and access subsets of the timeline, calendar, or documents. For example, various users may have different roles within a company, business, or any form of organization. The various users may have different roles with respect to payroll. Based on their roles, users may or may not have limited access. For example, a payroll specialist for a company may have access to most of the timeline, calendar, or documents of that company. A payroll assistant working in primarily one area of payroll may have access to payroll documents within that area. A group manager may have access to documents or information on the timeline relating to his or her group of employees. Users outside the company may also access the timeline with filtered exposure. For example, auditors or accountants may be able to access relevant portions of the timeline along with related documents. Such filters based on user roles may prevent users from accessing information that they are not authorized to access. Similarly, such filters may provide users with information that is relevant to their task, so they are not confused by irrelevant clutter.

The user interface may also include a selection organizer where selected or highlighted documents may be organized and presented with additional details. The selection organizer may be a pane or region of any shape that may be displayed along with the timeline. In some embodiments, the selection organizer may be displayed as a column. The selection organizer may display documents or document packets. The documents may be listed in full with document names, sizes, versions, dates, or any other document-related data. Individual documents may be downloaded, or entire document collections may be downloaded as an ensemble. User interactions with each document may be visible in the selection organizer. For instance, documents that have already been downloaded may be marked as such (e.g., similar to how a read email may be marked as such). Similarly, record may be provided as to who downloaded the document. Using the selection organizer, any single document may be downloaded, an entire group of documents may be downloaded, or an entire section may be downloaded. In some instances, the documents may be downloaded as a zip file.

Any item visible on a timeline may be selectable and may remain highlighted when selected. Once selected, the selection organizer may be updated with icons and/or details about the selected item. If the item selected is a collection of documents, the selection organizer may list them all and may organize them into topic sections. A calendar date, calendar event, or calendar unit (e.g., month) may be selected that may include visible items. The selection organizer may include one or more document boxes, each with one or more selections, each selection with one or more documents. Special download of general ledger files may enable standard user tasks with those files. Such tasks may include the option to download the latest version of the files, a first-time download of the file (for starting up), a recovery download, or access to specific dates.

A user's favorite recurring reports may be tagged for quick-access inclusion in a payroll software, payroll application tool, or for email alert. Users may request direct attachment and delivery of favorite documents with encryption and personal password access.

A timeline may be extended for two way document collection and dissemination. For example, users may contribute document portions or entire documents with certain data. Similarly, the users may contribute document requests. The users may be presented with an active document drop zone directly onto the timeline. This may support fully secured multi-direction document workflow within a company and with its partners. One example of multi-directional workflow may be when an external accountant using another system's financial software uploads audit documents or financial plans for review by a company. Two way document dissemination via a timeline may also be useful when financial managers may be required to add a digital signature to a document before filing. Managers may also download a bonus spreadsheet, update the spreadsheet with recommendations for direct employee reports, and upload the updates to the timeline using the two-way interaction. In some embodiments, a drop zone may have a drag-and-drop interaction. A user may drag and drop a document or document request onto a desired location along a timeline, such that the document or request may then be available at that location at a later time or to other users. Alternatively, a designated drop zone may be provided, which may receive the document or request from the user and automatically place the document or request at the proper location on the timeline. Any other technique for uploading a document or request may be used.

Two-way document dissemination may be implemented in various ways. For example, in some instances, a document may be displayed only relating to a relevant time in one way—e.g., documents may appear on the timeline in relation to the time when they are due only, or when they are created, updated, edited, reviewed, submitted or destroyed. For example, if the document would only be displayed in relation to the document submission deadline, regardless of when the document was edited or created, the document may always be displayed at the same time-location. In some instances, a user may change the submission deadline for the document, in which case the document may be displayed at the new submission deadline.

In other instances, documents may be displayed on the timeline such that they may relate to a relevant time in multiple ways. For example, a document may be created at a first time, time A, and then may be opened and edited by a user at time B, and then may be opened and reviewed by a user at time C without any changes being made. In some embodiments, a document icon may be present at each of time A, B, or C, showing the different states of the document. In some instances, different icons may be provided for different actions (an icon may be provided for when a document was created that may be different from an icon that may be provided for a document that was submitted, etc.). In other embodiments, a document icon may only be presented at one, or some of time A, B, or C. For example, a document icon may only be presented at the most recently updated version of the document, which may be time B. In some instances, the system may automatically recognize when the document was last updated and automatically move the updated document icon to the new time-location on the timeline. In other instances, a user may select where to place the updated document icon.

Alerts relating to timeline documents may be provided. For example, timeline users or subscribers may receive email notices when documents of interest are ready or are due. In addition to email notices, such alerts may be delivered in any manner known in the art, e.g., text message, automated voicemail, chat window, or a pop-up appearing when the user accesses the interface. Such alerts may include a direct link to a correct timeline focus, time window, or document highlight. Users with different roles may collaborate and receive alerts with filtered timeline exposures. For example, users may only receive emails relating to documents or events pertaining to an area they are involved in. In some instances, emails or other alerts may deliver actual documents to users in a personally encrypted format.

The timeline may be provided as part of a human capital management software that may be provided to one or more company, business, or any other sort of organization. Any party licensing the timeline application, or any larger application that the timeline may be a part of, may superimpose the party's business data and event rules. The timeline may be augmented with payroll domain knowledge and rules or a library of various business calendar calculations. The user may be able to add or derive proprietary organization events and business planning onto an immediately shared time-based interface.

In one example, a company may add all bonus submission deadlines with a business rule: all bonus submissions must be made 10 business days before a quarterly payroll. Managers may view a downloadable Excel document with prior data, and return their proposal in a drop zone. A user may impose any such similar rules, such as how many days before an event that various documents have to be submitted by. In another example, automated distribution may be provided company-wide to same-level managers showing their group payroll budget, or group participation in company sponsored deduction plans may be provided. Thus, a user may impose similar rules where certain documents may be distributed to certain parties automatically. In yet another example, on Jan. 29, 2009, all upcoming employee birthdays for Aquarius may be provided. Thus, a user may impose similar rules to have particular events be displayed on the timeline. Additional business rules may be provided, such as business day calculations, work weeks, payroll frequencies, filing dates, government audit deadlines, EEO and HR audits, and any other business rules may be determined by a user and implemented on a timeline.

In some implementations, a user may be a multi-business accountant persona. For example, an accountant may work with multiple businesses that may have their own sets of deadlines, rules, and documents. When the accountant accesses a timeline interface, entire businesses may be remapped on top of the timeline with business rules and alerts. For instance, if the accountant is working with a first business, all of those business' events, documents and dates may be displayed on the timeline. When the accountant starts working on matters for a second business, the first business' items may be removed from the timeline, and the second business' items may be superimposed over the timeline. Similarly, when the accountant is working on something for the first business, the first business' rules may apply to the timeline, while when the accountant is working on something for the second business, the second business' rules may apply to the timeline. In some instances, the accountant may impose the accountant's own rules which may carry over between businesses. For example, if the accountant has a preference for being reminded 3 days before a due date, this may apply to the timeline even when the accountant is working with any business. Such multi-business flexibility may apply for any user who may access one or more business.

The timeline may advantageously provide continuity, and allow for the application of business rules and payroll domain knowledge. The timeline may also provide for recurrence rules. The timeline may also support computation placement of data. Such features may provide the timeline with greater robustness and flexibility over pre-existing calendar features, such as Google calendars or other calendar mediums, and Google, Mapquest, or other online maps.

A timeline that may be utilized by multiple businesses may be implemented from a software as a service (SAAS), or in partnership with a centralizer (e.g., Google). The timeline may thus be provided as a standalone application, as part of a larger application, or in partnership with another entity. The timeline may be powered by the entity, and the business may be by a human capital management entity.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A graphical timeline for displaying human capital management data comprising:
a plurality of time period indicators covering a defined time interval;
one or more human capital management item timelines each divided by the time period indicators, wherein each human capital management item timeline includes a data value for a human capital management item at a time period on the payroll item timeline; and
at least one document icon providing access to human capital management information, wherein the document icon is displayed relative to a relevant time period indicator.

2. The graphical timeline of claim 1 wherein at least one human capital management items relates to payroll data.

3. The graphical timeline of claim 1 wherein the plurality of time period indicators indicate pay periods.

4. The graphical timeline of claim 2 wherein the human capital management item timelines are grouped by topic.

5. The graphical timeline of claim 1 wherein a document represented by the document icon has several states of readiness.

6. The graphical timeline of claim 5 wherein the graphical timeline sends notices when documents of interest are ready or due.

7. The graphical timeline of claim 1 further comprising a document viewing pane where a selected and highlighted document is presented with additional details.

8. The graphical timeline of claim 2 wherein the human capital management items include at least one of: 401(k), CAF, GarnIRS, ChSupp, or Advance Data.

9. The graphical timeline of claim 8 wherein the size is variable depending on the application utilizing the graphical timeline.

10. The graphical timeline of claim 1 further comprising an event marker, wherein the event marker is displayed relative to relevant time period indicators.

11. A graphical interface for a human capital management system comprising:
a plurality of graphical human capital management item timelines that are divided into selected time intervals, wherein at least one human capital management item timeline includes: a first data value corresponding to a first period of time for a selected human capital management item; and a second data value corresponding to a second period of time for the selected human capital management items; and
at least one information filter configured to affect the display of a human capital management item timelines.

12. The system of claim 11 wherein the information filter affects the display of human capital management item timelines in at least one of the following manners: modifying time periods displayed, or modifying human capital management items displayed.

13. A method for displaying human capital management data comprising:
displaying a graphical timeline with a plurality of time period indicators covering a defined time interval on a video display;
displaying one or more human capital management item timelines divided by the plurality of time period indicators on the video display;
showing a change indicator on the human capital management item timeline that indicates a data value change for the human capital management item; and
providing at least one active document drop zone configured to accept a document to be displayed on the graphical timeline.

14. The method of claim 13 further comprising adding an additional human capital management item, with its own human capital management item timeline.

15. The graphical timeline of claim 13 wherein the document accepted by the document drop zone is displayed at a location relative to a relative time period indicator.

16. The method of claim 15 wherein a time period indicator is relevant if it represents a time when: the document submission is due, the document was created, the document was updated, the document was reviewed, the document was submitted, the document submission reminder is being effected, or the document is destroyed.

17. The method of claim 13 further comprising displaying information about a human capital management item when: a user clicks on a human capital management item timeline, or when a pointing device indicator is over a human capital management item timeline.

18. The method of claim 17 wherein displaying information includes at least one of the following: displaying information on a popup, displaying information in a new window, or displaying information in a page so that the user navigates away from the previous page.

19. The method of claim 13 wherein the document accepted by the document drop zone is a payroll document, a human capital management document, or a human resources document.

20. A method for displaying human capital management data comprising:
displaying a graphical timeline with a plurality of time period indicators covering a defined time period on a video display;
displaying one or more human capital management document icon on the video display, wherein the one or more human capital management document provides access to additional information and is visually mapped to a relevant time period indicator; and
displaying one or more human capital management event indicator on the video display, wherein the one or more human capital management event indicator is visually mapped to a relevant time period indicator.
